(19) United States
(12) Patent Application Publication
(10) Pub. No.: US 2025/0355398 A1
(43) Pub. Date: Nov. 20, 2025

(54) IMAGE FORMING APPARATUS

(71) Applicant: CANON KABUSHIKI KAISHA, Tokyo (JP)

(72) Inventor: Iku Shimizu, Chiba (JP)

(21) Appl. No.: 19/195,862

(22) Filed: May 1, 2025

(30) Foreign Application Priority Data
May 20, 2024 (JP) 2024-081670

(51) Int. Cl. G03G 15/00; G03G 15/16

(52) U.S. Cl. CPC G03G 15/6564; G03G 15/1615; G03G 15/50; G03G 2215/00599

(57) ABSTRACT

An image forming apparatus includes an image bearing member, a belt, an outer roller, an inner roller, a tension roller, a conveyance roller pair, a guide member including a convex portion, a belt drive motor configured to drive the belt, a torque sensor configured to detect a torque of the belt drive motor, and a control unit configured to execute, after the sheet has reached the transfer nip, a conveyance control of controlling a rotational speed of the conveyance roller pair such that a first conveyance speed of the sheet conveyed by the transfer nip becomes faster than a second conveyance speed of the sheet conveyed by the conveyance roller pair based on a detection result of the torque sensor.

### BACKGROUND

### Field of the Technology

The present disclosure relates to an image forming apparatus for forming images on sheets.

### Description of the Related Art

Generally, image forming apparatuses cause toner images formed on an intermediate transfer belt or a photosensitive drum to be transferred onto a sheet at a transfer portion, and thereafter, fix the toner image to the sheet by applying heat and pressure thereto. A registration roller pair is disposed upstream of the transfer portion, and a state occurs in which the sheet is positioned astride both the transfer portion and the registration roller pair. It is generally known that if the sheet is positioned astride both rollers, due to a slight difference in rotational speeds of the rollers, pulling or pushing of the sheet occurs by the registration roller pair. As a result, a posture of the sheet may become unstable at a position upstream of the transfer portion, which may lead to image defects. For example, due to a tolerance of outer diameters of the registration roller pair, the conveyance speeds of the sheet by the registration roller pair and by the transfer portion may be varied.

Therefore, Japanese Patent Application Laid-Open Publication No. 2011-081347 proposes an image forming apparatus in which a set torque of a secondary transfer roller in a state where the sheet is conveyed only by the transfer portion is stored in a memory. The image forming apparatus obtains a torque deviation by subtracting, from the set torque, a measured torque of the secondary transfer roller in a state where the sheet is conveyed by both the registration roller pair and the transfer portion, and controls the rotational speed of the registration roller pair such that the torque deviation becomes zero. Thereby, the proposed image forming apparatus attempts to suppress puling or pushing of the sheet by the registration roller pair.

However, especially in a case where a sheet having a low stiffness is used, a difference in conveyance speed of the sheet between the transfer portion and the registration roller pair may affect the posture of the sheet, but in a state where the sheet is pushed into the transfer portion, the difference in conveyance speed does not easily cause variation of driving torque of the secondary transfer roller. This is caused by a loop being formed on the sheet when the sheet is pushed into the transfer portion. Therefore, even in a case where the rotational speed of the registration roller pair is controlled such that the torque deviation becomes zero, as taught in Japanese Patent Application Laid-Open Publication No. 2011-081347, the posture of the sheet may not be stabilized sufficiently, especially in a case where the stiffness of the sheet is low.

### SUMMARY

According to a first aspect of the present disclosure, an image forming apparatus includes an image bearing member configured to bear a toner image, a belt onto which the toner image is transferred from the image bearing member while the belt is being rotated in a rotational direction, an outer roller configured to come into contact with an outer circumference surface of the belt, an inner roller arranged to face the outer roller with the belt interposed therebetween, the inner roller being configured to come into contact with an inner circumference surface of the belt and to form a transfer nip with the outer roller, a tension roller configured to come into contact with the inner circumference surface of the belt, the tension roller being disposed upstream of the inner roller in the rotational direction, a conveyance roller pair configured to convey a sheet toward the transfer nip, a guide member configured to guide the sheet being conveyed by the conveyance roller pair toward the transfer nip, the guide member including a convex portion that projects toward the outer circumference surface of the belt and that is arranged between a virtual line that passes through a nip of the conveyance roller pair and the transfer nip and a virtual line that extends along the outer circumference surface of the belt being stretched between the tension roller and the inner roller, a belt drive motor configured to drive the belt, a torque sensor configured to detect a torque of the belt drive motor, and a control unit configured to execute, after the sheet has reached the transfer nip, a conveyance control of controlling a rotational speed of the conveyance roller pair such that a first conveyance speed of the sheet conveyed by the transfer nip becomes faster than a second conveyance speed of the sheet conveyed by the conveyance roller pair based on a detection result of the torque sensor.

According to a second aspect of the present disclosure, an image forming apparatus includes an image bearing member configured to bear a toner image, a belt onto which the toner image is transferred from the image bearing member while the belt is being rotated in a rotational direction, an outer roller configured to come into contact with an outer circumference surface of the belt, an inner roller arranged to face the outer roller with the belt interposed therebetween, the inner roller being configured to come into contact with an inner circumference surface of the belt and to form a transfer nip with the outer roller, a tension roller configured to come into contact with the inner circumference surface of the belt, the tension roller being disposed upstream of the inner roller in the rotational direction, a conveyance roller pair configured to convey a sheet toward the transfer nip, a guide member configured to guide the sheet being conveyed by the conveyance roller pair toward the transfer nip, the guide member including a convex portion that projects toward the outer circumference surface of the belt and that is arranged between a virtual line that passes through a nip of the conveyance roller pair and the transfer nip and a virtual line that extends along the outer circumference surface of the belt being stretched between the tension roller and the inner roller, a belt drive motor configured to drive the belt, a torque sensor configured to detect a torque of the belt drive motor, and a control unit configured to execute a conveyance control of controlling a rotational speed of the conveyance roller pair such that a torque detected by the torque sensor when the sheet is nipped by the conveyance roller pair and the transfer nip becomes greater than a torque detected by the torque sensor when the sheet is nipped and conveyed only by the transfer nip.

Features of the present disclosure will become apparent from the following description of embodiments with reference to the attached drawings. The following description of embodiments are described by way of example.

### BRIEF DESCRIPTION OF THE DRAWINGS

FIG. 1 is an entire schematic view of a cross-sectional configuration of an image forming apparatus.

FIG. 2 is a schematic diagram of a peripheral configuration of a transfer nip.

FIG. 3 is a block diagram of a control block of a control unit provided in the image forming apparatus.

FIG. 4 is a graph illustrating a torque fluctuation of a belt drive motor.

FIG. 5A is a schematic diagram of a behavior of a sheet.

FIG. 5B is an enlarged view of FIG. 5A.

FIG. 6 is a flowchart of print control.

FIG. 7 is a flowchart of print control.

FIG. 8A is a schematic diagram of a guide member according to a modified example.

FIG. 8B is an enlarged view of FIG. 8A according to the modified example.

### DESCRIPTION OF THE EMBODIMENTS

### Entire Configuration

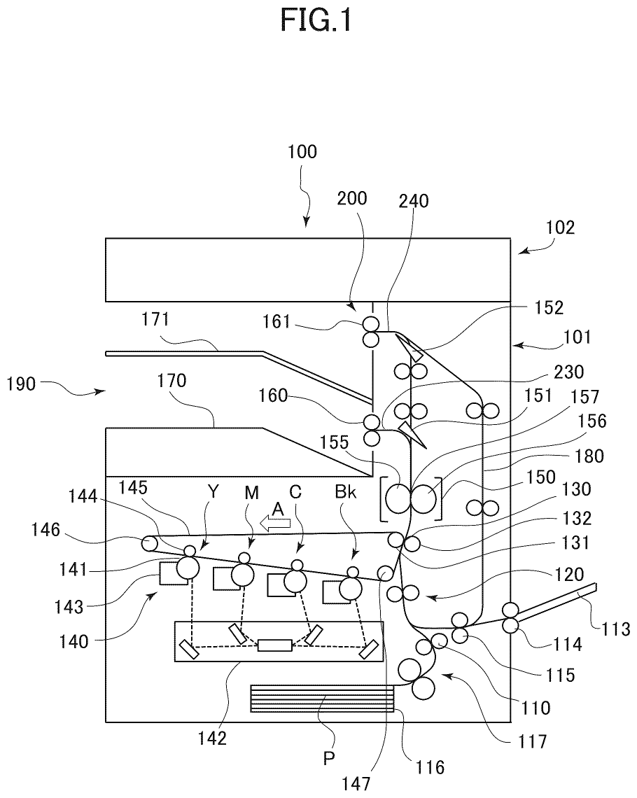

FIG. 1 is an entire schematic view of a cross-sectional configuration of an image forming apparatus 100 according to a present embodiment. The image forming apparatus 100 includes an image forming unit 140 for forming an image on a sheet P serving as a recording material, a sheet feed unit 117, a fixing unit 150, a sheet discharging device 200, and an image reading apparatus 102. Further, the image forming apparatus 100 includes an apparatus body 101, which is a casing accommodating the image forming unit 140.

The image forming apparatus refers to an apparatus that forms images on sheets serving as recording media based on image information entered from an external PC or an image information read from documents, and includes a printer, a copying machine, a facsimile, and a multifunction device. Further, in addition to a main body having an image forming function, the image forming apparatus may have auxiliary devices such as an optional feeder, an image reading apparatus, or a sheet processing apparatus connected thereto, and in that case, the entire system including the connected auxiliary devices is recognized as one type of the image forming apparatus.

The image forming unit 140 is an intermediate-transfer tandem-type electrophotographic unit in which image forming stations Y, M, C, and Bk for forming toner images of four colors are arranged along an intermediate transfer belt 145.

The sheet P is accommodated in a cassette 116 disposed at a lower portion of the apparatus body 101, and the sheets are fed one by one by the sheet feed unit 117. The sheet feed unit 117 includes, for example, a feed roller for feeding the sheets P, and a separation roller arranged in contact with the feed roller and separating the sheet P being fed by the feed roller from other sheets P by applying a frictional force to the sheet P. Various types of sheets having various sizes and materials may be used as the sheet P serving as a recording material, such as paper including normal paper and thick paper, plastic films, cloths, sheet materials such as coated paper subjected to surface treatment, and sheet materials having special shapes such as envelopes and index paper.

The sheet P fed by the sheet feed unit 117 is conveyed by a pre-registration roller pair 110 to a registration roller pair 120. Then, skewing of the sheet P is corrected by the registration roller pair 120 serving as a conveyance roller pair, and the sheet P is conveyed toward a transfer nip 130 at a timing synchronized with a toner image forming process by the image forming unit 140.

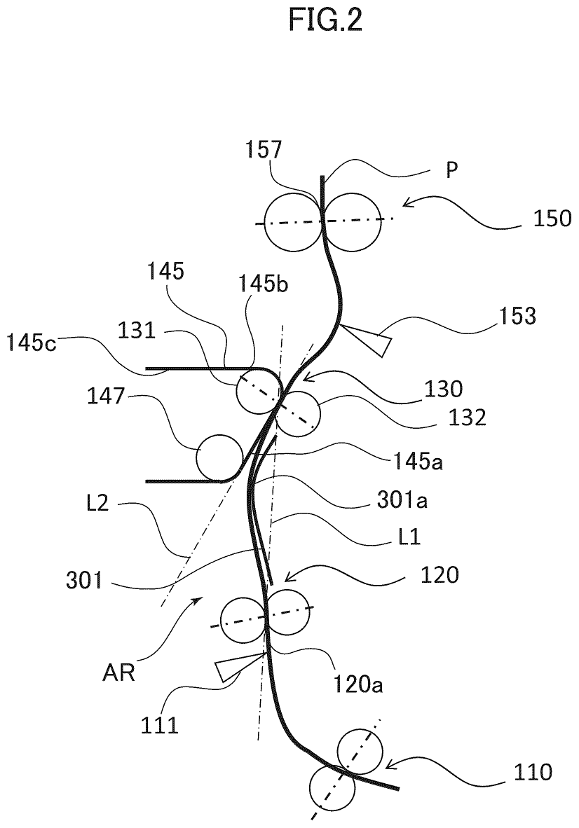

The image forming unit 140 includes an intermediate transfer belt 145 onto which a toner image is transferred from a photosensitive drum 141, and a secondary transfer outer roller 132 serving as an outer roller that comes into contact with an outer circumference surface 145b (refer to FIG. 2) of the intermediate transfer belt 145. Further, the image forming unit 140 includes a driving roller 131 that is arranged to face the secondary transfer outer roller 132 with the intermediate transfer belt 145 interposed therebetween, that comes into contact with an inner circumference surface 145c of the intermediate transfer belt 145, and that forms the transfer nip 130 together with the secondary transfer outer roller 132. The transfer nip 130 nips and conveys the sheets. Furthermore, the image forming unit 140 includes a tension roller 147 that comes into contact with the inner circumference surface 145c (refer to FIG. 2) of the intermediate transfer belt 145, and that is arranged upstream of the driving roller 131 in an arrow A direction.

The intermediate transfer belt 145 is wound around the driving roller 131, a tension roller 146, a plurality of primary inner rollers 144, and the tension roller 147, and stretched with a predetermined tension. By driving the driving roller 131, the intermediate transfer belt 145 rotates in the arrow A direction. Thereby, the intermediate transfer belt 145 forms a belt inclined surface 145a that is positioned between the tension roller 147 and the driving roller 131 in the arrow A direction and that guides the sheet P toward the transfer nip 130. The belt inclined surface 145a is a portion of the outer circumference surface 145b. The tension roller 147 is positioned upstream of the driving roller 131 in the arrow A direction.

In parallel with a conveyance process of the sheet P to the transfer nip 130 described above, the image forming unit 140 executes a toner image forming process. The image forming stations Y, M, C, and Bk of the image forming unit 140 each include the photosensitive drum 141 serving as a drum-shaped image bearing member, i.e., electrophotographic photosensitive member, a charging unit such as a charging roller, and a developing unit 143 serving as a developing portion. The image forming unit 140 further includes an exposing unit 142 disposed below the four photosensitive drums 141. In the toner image forming process, the charging unit charges the surface of the photosensitive drum 141 uniformly, the exposing unit 142 exposes the photosensitive drum 141 based on a signal corresponding to an image information of the image to be formed, by which an electrostatic latent image is formed on the surface of the photosensitive drum 141. The electrostatic latent image is developed by toner supplied from the developing unit 143, and a single-color toner image is formed. Thereby, toner images of four colors, which are yellow, magenta, cyan, and black, are formed on the surfaces of the four photosensitive drums 141.

The intermediate transfer belt 145 serving as a belt is driven to rotate in the arrow A direction serving as a rotational direction in FIG. 1. The toner images borne on the four photosensitive drums 141 are sequentially primarily transferred by the primary inner rollers 144 onto the intermediate transfer belt 145 in a mutually superposed manner. As a result, finally, a full-color toner image is formed on the intermediate transfer belt 145, which is borne on the intermediate transfer belt 145 and conveyed to the transfer nip 130. By having pressure and transfer bias applied at the transfer nip 130, the toner image is secondarily transferred from the intermediate transfer belt 145 onto the sheet P. When secondarily transferring the toner image onto the sheet P, a secondary transfer voltage is applied from a high voltage power supply to either the driving roller 131 or the secondary transfer outer roller 132.

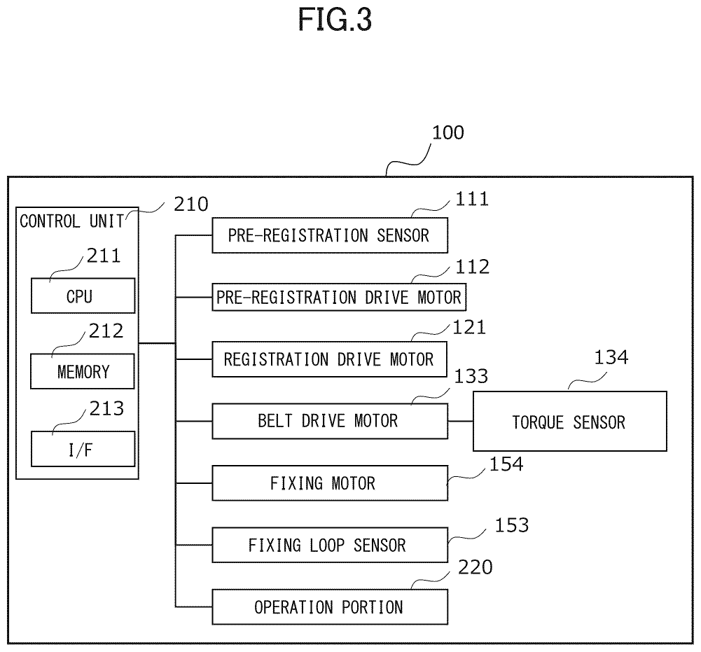

The sheet P having passed through the transfer nip 130 is conveyed to the fixing unit 150. The fixing unit 150 includes a fixing roller 155 having a heater disposed therein, and a pressure roller 156 that comes into contact with the fixing roller 155 with a predetermined pressing force. The fixing roller 155 is driven by a fixing motor 154 (refer to FIG. 3) described below, and the pressure roller 156 is driven to rotate following the fixing roller 155. The fixing unit 150 applies pressure and heat to the toner image on the sheet P while nipping and conveying the sheet P by a fixing nip 157 serving as a fixing portion formed by the fixing roller 155 and the pressure roller 156. Toner is melted thereby, and toner is solidified after passing through the fixing nip, by which an image fixed to the sheet P is obtained.

The sheet P having passed through the fixing unit 150 is guided by a first guide member 151 to either a first sheet discharge passage 230 leading toward a first sheet discharge roller pair 160 or a second sheet discharge passage 240 leading toward a second sheet discharge roller pair 161. When forming images on both surfaces of the sheet P, the sheet P having an image formed on a first surface is guided by the first guide member 151 toward the second sheet discharge roller pair 161 and conveyed to the exterior of the apparatus by the second sheet discharge roller pair 161. When a trailing edge of the sheet P in the conveyance direction passes through a second guide member 152, the second sheet discharge roller pair 161 reverses the conveyance direction of the sheet P and sends the sheet P into a duplex conveyance path 180. A portion of the sheet P that projects to an outer side of the apparatus body 101 during reverse operation performed by the second sheet discharge roller pair 161 is supported by a second sheet discharge tray 171. The sheet P having reached the registration roller pair 120 again via the duplex conveyance path 180 has an image formed on a second surface by passing through the transfer nip 130 and the fixing unit 150 after skew correction and timing correction.

The sheet discharging device 200 for discharging the sheet P to the exterior of the apparatus, that is, to the outer side of the apparatus body 101, is disposed downstream of the fixing unit 150 in the sheet conveyance direction. The sheet discharging device 200 includes the first sheet discharge roller pair 160, the second sheet discharge roller pair 161, a first sheet discharge tray 170, and the second sheet discharge tray 171.

When discharging the sheet P, the sheet P sent out from the fixing unit 150 is guided by the first guide member 151 to the first sheet discharge roller pair 160, and discharged by the first sheet discharge roller pair 160 to the outer side of the apparatus body 101. The first sheet discharge tray 170 is disposed on the upper portion of the apparatus body 101, and the sheet P discharged by the first sheet discharge roller pair 160 is supported, or stacked, on the first sheet discharge tray 170. The sheet P supported on the first sheet discharge tray 170 or the second sheet discharge tray 171 is slid on an inclined surface of the first sheet discharge tray 170 or the second sheet discharge tray 171 by its own weight, and the sheet is aligned by having the trailing edge of the sheet abut against an alignment surface of the apparatus body 101.

The image forming apparatus 100 includes the image reading apparatus 102 disposed on an upper portion of the apparatus body 101. The image reading apparatus 102 includes a platen glass on which a document is to be placed, and an image sensor that reads an image on the document via the platen glass. Further, the image reading apparatus 102 includes an auto document feeder that feeds documents set on a document tray one sheet at a time to have the image read by the image sensor. The image forming apparatus 100 according to the present embodiment adopts a so-called in-body sheet discharge configuration in which an in-body sheet discharge space 190 of the sheet P is disposed between the image forming unit 140 and the image reading apparatus 102 in the up-down direction. The in-body sheet discharge configuration is advantageous in that an occupation area of the image forming apparatus 100 viewed from above may be made smaller compared to an arrangement in which the first sheet discharge tray 170 is disposed on the side portion of the apparatus body 101 and the sheet discharge space is arranged on the side of the apparatus body 101.

Further, the image forming unit 140 described above is an example of an image forming unit, and it may be possible to adopt a direct transfer-type electrophotographic unit in which the toner image formed on a photosensitive member is transferred onto the sheet without interposing an intermediate transfer body. Further, the sheet P may be fed from a multi-purpose tray 113 disposed in an openable/closable manner on the side surface of the apparatus body 101. The sheet P supported on the multi-purpose tray 113 is conveyed by a conveyance roller pair 114 to a drawing roller pair 115. The sheet P is conveyed to the registration roller pair 120 by the drawing roller pair 115, and the toner image is formed as described above.

### Peripheral Configuration of Transfer Nip

Next, with reference to FIG. 2, a peripheral configuration of the transfer nip 130 will be described with further detail. FIG. 2 is a schematic diagram of a peripheral configuration of the transfer nip 130. As illustrated in FIG. 2, a pre-registration sensor 111 is disposed between the pre-registration roller pair and the registration roller pair 120. By having a leading edge of the sheet P conveyed by the pre-registration roller pair 110 abut against and aligned by a nip of the registration roller pair 120 in a stopped state, skewing of the sheet P is corrected. The registration roller pair 120 is driven at a matched timing with the transfer of toner image onto the sheet based on a timing at which the pre-registration sensor 111 has detected the leading edge of the sheet P.

A guide member 301 that guides the sheet P conveyed by the registration roller pair 120 toward the transfer nip 130 is disposed between the registration roller pair 120 and the transfer nip 130. The guide member 301 includes a convex portion 301a that is projected toward the belt inclined surface 145a of the intermediate transfer belt 145 described above. The convex portion 301a is disposed in an area AR between a virtual line L1 that passes through a nip 120a of the registration roller pair 120 and the transfer nip 130, and a virtual line L2 that extends along the belt inclined surface 145a. The virtual line L2 is also a common tangent of the driving roller 131 and the secondary transfer outer roller 132 at the transfer nip 130.

The guide member 301 is arranged on an opposite side from the driving roller 131 with respect to the virtual line L2, that is, on a non-imaging surface side. As described below, the sheet P nipped by the transfer nip 130 and the registration roller pair 120 is conveyed to be moved in sliding motion against the convex portion 301a of the guide member 301. Therefore, the guide member 301 serves as a conveyance load while conveying the sheet P. Further, a fixing loop sensor 153 that detects an amount of deflection, hereinafter also referred to as a loop, of the sheet P is arranged between the transfer nip 130 and the fixing unit 150.

### Control Block

FIG. 3 is a block diagram illustrating a control block of a control unit 210 provided in the image forming apparatus 100. As illustrated in FIG. 3, the control unit 210 includes a CPU 211, a memory 212, and an interface portion 213.

The Central Processing Unit (CPU) 211 is an element that performs arithmetic processing. The memory 212 includes a Read Only Memory (ROM) and a Random Access Memory (RAM). The RAM stores information entered to the control unit 210, information detected by various sensors, and arithmetic results. The ROM stores control programs and data acquired in advance. The CPU 211 and the memory 212 may transfer and read data mutually. The interface portion (I/F) 213 controls input/output of signals between the control unit 210 and devices connected to the control unit 210.

Various units of the image forming apparatus 100, such as the image forming unit 140, driving devices of the intermediate transfer belt 145 and members regarding conveyance of the sheet P, and various power supplies, are connected to the control unit 210. For example, a belt drive motor 133 and various high voltage power supplies not shown, such as a charging voltage, a developing voltage, a primary transfer voltage, and a secondary transfer voltage, are connected to the control unit 210. Further, signals indicating the detection result, i.e., output value, of current values of various drive motors are entered to the control unit 210 and stored in the memory 212.

Further, a pre-registration drive motor 112, a registration drive motor 121, and the fixing motor 154 are connected to the control unit 210. The pre-registration drive motor 112 drives the pre-registration roller pair 110. The registration drive motor 121 serving as a conveyance motor drives the registration roller pair 120. The fixing motor 154 drives the fixing roller 155. Further, the pre-registration roller pair 110 and the registration roller pair 120 each include a drive roller and a driven roller driven to rotate following the rotation of the drive roller, and the drive rollers are each driven by the pre-registration drive motor 112 and the registration drive motor 121. The pressure roller 156 of the fixing unit 150 is driven to rotate following the rotation of the fixing roller 155. Alternatively, the fixing motor 154 may be set to drive the pressure roller 156, and the fixing roller 155 may be driven to rotate following the rotation of the pressure roller.

The belt drive motor 133 drives the driving roller 131 so as to cause the intermediate transfer belt 145 to rotate in the arrow A direction (FIG. 1). Further, the belt drive motor 133 includes a torque sensor 134 that may continue to detect a driving load, i.e., torque, of the belt drive motor 133 at an arbitrary time interval. In the present embodiment, a current detection unit that detects the current flowing in the belt drive motor 133 is used as an example of the torque sensor 134. A torque fluctuation information of the belt drive motor 133 collected by the torque sensor 134 is stored in the memory 212.

An operation portion 220 is connected to the control unit 210. The operation portion 220 includes a display portion such as a display panel for displaying information, and an input portion for entering information to the control unit 210 by operation performed by an operator such as a user or a service staff. The operation portion 220 may be composed of a touch panel having the functions of the display portion and the input portion. Further, the image reading apparatus 102 or external apparatuses such as a personal computer connected to the image forming apparatus 100 may be connected to the control unit 210.

The control unit 210 controls various units of the image forming apparatus 100 to have an image formed based on a job information. The job information may include information related to a printing operation, such as the attribute of the sheet P, i.e., instruction signal, in addition to information regarding a sheet feeder, a start instruction, i.e., start signal, and image information which are entered from the operation portion 220 or external devices. The information related to the attribute of the sheet P, hereinafter simply referred to as “information related to the sheet”, includes arbitrary information for identifying the sheet, such as types of sheet including normal paper, high quality paper, glossy paper, coated paper, and embossed paper, i.e., so-called paper type category, numerical values or numerical ranges such as grammage, thickness, and size, and brands, such as the name of the manufacturer or the product number.

According to the present embodiment, information related to the attribute of the sheet P may include information regarding stiffness of the sheet P, such as the grammage information of the sheet P. In a case where information related to printing operation conditions is entered from the operation portion 220, the operation portion 220 functions as an input portion for entering the information related to the grammage of the sheet P onto which the toner image is to be transferred to the control unit 210. Further, in a case where information related to the printing operation condition is entered from an external device such as a personal computer, the interface portion 213 functions as an input portion for entering the information related to the grammage of the sheet P onto which the toner image is to be transferred to the control unit 210.

The image forming apparatus 100 executes a job, i.e., print job, which is a series of operations related to forming an image on one or more sheets P and outputting the same, which is started based on one start instruction. The job generally includes an image forming process, i.e., printing operation and image forming operation, a pre-rotation process, a sheet interval process of a case where images are to be formed on a plurality of sheets P, and a post-rotation process. The image forming process is a process for forming an electrostatic latent image of the image to be actually formed and output on the sheet P, forming a toner image, and performing primary transfer and secondary transfer of the toner image, wherein the term “during image forming” refers to this section of the process. The pre-rotation process is a process for performing a preparation operation prior to the image forming process from when the start instruction is entered until the image is actually started to be formed. The sheet interval process is a process that corresponds to the interval between the sheet P and a subsequent sheet P when image formation is continuously performed to a plurality of sheets P, i.e., during continuous image formation. The post-rotation process is a process for performing an organization operation, i.e., preparation operation, subsequent to the image forming process. A non-image-forming timing, i.e., non-image-forming section, is a section other than when forming images, and includes the pre-rotation process, the sheet interval process, the post-rotation process, and a pre multiple-rotation process which is a preparation process when turning on the power of the image forming apparatus 100 or when returning from a sleep state.

The sleep state, i.e., resting state, is a state in which supply of power to respective portions of the image forming apparatus 100 other than the control unit 210 or a portion thereof is stopped, and the amount of power consumption is reduced compared to the standby state. According to the present embodiment, a current value of the belt drive motor 133 is stored constantly in the image forming process. The current value is stored in the memory 212 as a torque fluctuation data, that is, as a fluctuation data of torque Tq of the belt drive motor 133.

### Torque Fluctuation of Belt Drive Motor

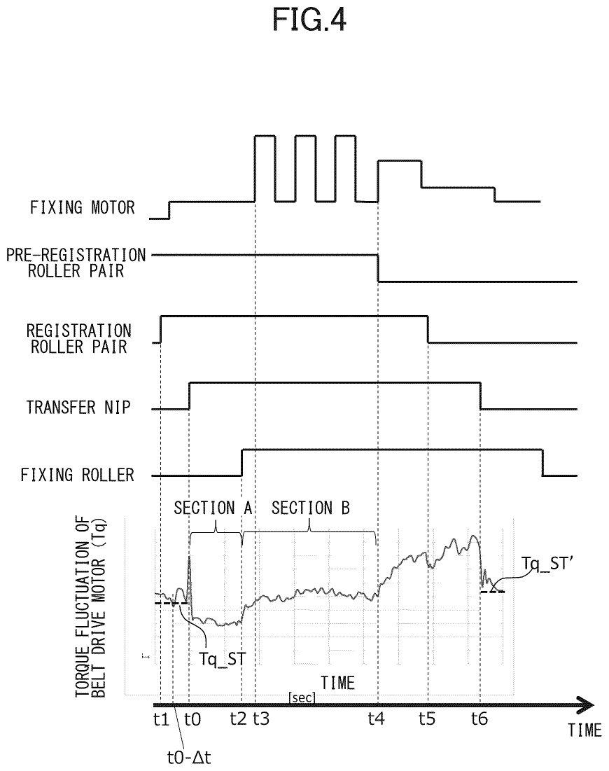

Next, a torque fluctuation of the belt drive motor 133 detected by the torque sensor 134 will be described with reference to FIG. 4. FIG. 4 is a graph illustrating a torque fluctuation of the belt drive motor 133. Times t1 to t5 described below are computed based on a distance between the respective rollers, a length of the sheet P in the conveyance direction, and a rotational speed of each roller, based on a time t0 at which the sheet P reaches the transfer nip 130.

As illustrated in FIG. 4, torque fluctuation occurs to the belt drive motor 133 by fluctuation of the load received from the sheet P passing through the transfer nip 130 and the load received via the intermediate transfer belt 145 and the driving roller 131. The torque Tq of the belt drive motor 133 varies according to which section of the conveyance path the sheet P is passing. According to the present embodiment, time t0 to time t2 is referred to as section A, and time t2 to time t4 is referred to as section B. Section A is a section from when the leading edge of the sheet P reaches the transfer nip 130, i.e., time to, until it reaches the fixing nip 157, i.e., time t2. Section B is a section from when the leading edge of the sheet P reaches the fixing nip 157, i.e., time t2, until the trailing edge of the sheet P reaches the nip of the pre-registration roller pair 110, i.e., time t4. In section B, after time t3 when the leading edge of the sheet P reaches the fixing loop sensor 153, the control unit 210 controls the fixing motor 154 to perform a loop control of controlling the amount of loop of the sheet P between the transfer nip 130 and the fixing nip 157.

FIG. 4 illustrates, from the upper stage in the named order, a rotational speed of the fixing motor 154, a conveyance period of the sheet P by the pre-registration roller pair 110, a conveyance period of the sheet P by the registration roller pair 120, a conveyance period of the sheet P by the transfer nip 130, a conveyance period of the sheet P by the fixing roller 155, and a torque fluctuation of the belt drive motor 133.

In FIG. 4, a stationary torque value at time (t0-Δt), which is a time prior to time t0 by Δt, that is, before the leading edge of the sheet P reaches the transfer nip 130, is referred to as an idle rotation torque value Tq_ST. That is, the idle rotation torque value Tq_ST is a driving load, i.e., torque, when driving the belt drive motor 133 in a state where the sheet P is not nipped by the transfer nip 130.

After the leading edge of the sheet P reaches the transfer nip 130 at time t0, in section A, the torque Tq transits at a value below the idle rotation torque value Tq_ST. The reason for this is that by having the sheet P conveyed to the transfer nip 130, conveyance force from the registration roller pair 120 is added as torque that drives the intermediate transfer belt 145 to the belt drive motor 133, and the torque Tq is reduced in response thereto.

In section B after section A, conveyance resistance is increased by the leading edge of the sheet P reaching the fixing nip 157, and a greater torque becomes necessary for conveying the sheet P. Therefore, the torque Tq of the belt drive motor 133 increases and transits at a value approximately above the idle rotation torque value Tq_ST.

Then, when the trailing edge of the sheet P passes through the pre-registration roller pair 110 at time t4, the conveyance force applied by the pre-registration roller pair 110 conveying the sheet P is lost, such that the torque Tq of the belt drive motor 133 is increased. Next, the trailing edge of the sheet P sequentially passes through the convex portion 301a of the guide member 301 (refer to FIG. 2) and the registration roller pair 120, i.e., time t5, and the torque Tq increases. Thereafter, at time t6 when the trailing edge of the sheet P passes through the transfer nip 130, the torque Tq of the belt drive motor 133 takes a stationary idle rotation torque value Tq_ST′.

As described above, fluctuation of the torque Tq of the belt drive motor 133 occurs when the leading edge of the sheet P reaches the nip of the respective roller pairs along the conveyance path, and when the trailing edge of the sheet P passes through the nip of the respective rollers pairs. Further, in general, the torque Tq also differs according to the attribute, such as the grammage or the stiffness, of the sheet P being conveyed. By subtracting the idle rotation torque value Tq_ST from the torque Tq of the belt drive motor 133, force other than that caused by the sheet P, such as the sliding load of the roller, may be removed, and in the following description, this torque is referred to as a sheet conveyance torque Tq_p. In other words, the sheet conveyance torque Tq_p is a value obtained by subtracting the idle rotation torque value Tq_ST from the torque Tq.

Behavior of Sheet before Transfer Nip

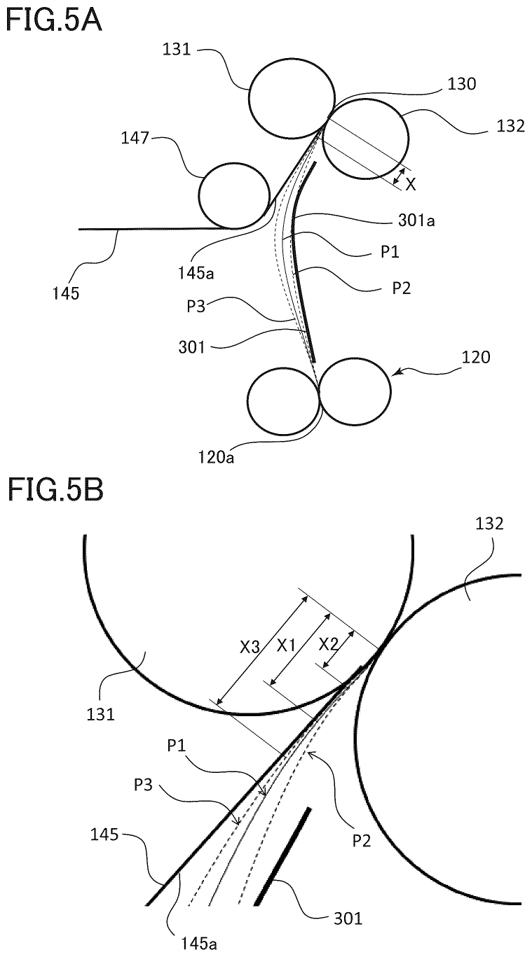

Next, with reference to FIGS. 5A and 5B, the behavior of the sheet P before reaching the transfer nip 130 will be described. FIG. 5A is a schematic diagram illustrating the behavior of the sheet P, and FIG. 5B is an enlarged view of FIG. 5A. As illustrated in FIG. 5A, the guide member 301 is arranged between the registration roller pair 120 and the transfer nip 130, and functions as a conveyance load during conveyance of the sheet P by having the sheet P move in sliding motion against the guide member 301. The sheet P is conveyed while forming a loop so as to approach the intermediate transfer belt 145 by being guided by the guide member 301.

For example, if an outer diameter of the registration roller pair 120 is equal to the nominal dimension, i.e., plan dimension value, the sheet P conveyed astride the registration roller pair 120 and the transfer nip 130 is conveyed in a posture P1. However, if the outer diameter of the registration roller pair 120 is smaller than the nominal dimension, the sheet P is conveyed in a posture P2 when the registration roller pair 120 rotates at a nominal speed. A looping amount of the sheet P is smaller in the posture P2 than in the posture P1. This is because the conveyance speed of the sheet P by the registration roller pair 120 is reduced by the outer diameter of the registration roller pair 120 being smaller than the nominal dimension.

Further, if the outer diameter of the registration roller pair 120 is greater than the nominal dimension, the sheet P is conveyed in a posture P3 when the registration roller pair 120 rotates at a nominal speed. The looping amount of the sheet P is greater in the posture P3 than in the posture P1. This is because the conveyance speed of the sheet P by the registration roller pair 120 is increased by the outer diameter of the registration roller pair 120 being greater than the nominal dimension.

In this state, if a distance in which the sheet P and the belt inclined surface 145a of the intermediate transfer belt 145 is in sliding contact is referred to as a distance X, as illustrated in FIG. 5B, the distance X will respectively be distance X1, X2, and X3 when the posture of the sheet P is posture P1, P2, and P3. The distance X2 is shorter than the distance X1, and the distance X3 is longer than the distance X2.

According to the present embodiment, an appropriate distance of the distance X is equal to or greater than the distance X2 and equal to or smaller than the distance X3. If the distance X is smaller than the distance X2, the sheet P may not be aligned along the belt inclined surface 145a. Then, the load on the secondary transfer power that supplies applying secondary transfer voltage to the secondary transfer outer roller 132 will be reduced, such that the secondary transfer voltage may be increased above an assumed value. If the secondary transfer voltage is increased above the assumed value, image defects such as image deterioration may occur, for example, by the occurrence of abnormal discharge to the sheet P. Meanwhile, if the distance X becomes greater than the distance X3, the sheet P may slide against the belt inclined surface 145a more than necessary, and image defects such as image rubbing may occur.

In the following description, in a case where the conveyance speed of the sheet by the registration roller pair 120 is slower than the conveyance speed of the sheet by the transfer nip 130, it is assumed that the sheet P is in a pulled state. Further, in a case where the conveyance speed of the sheet by the registration roller pair 120 is faster than the conveyance speed of the sheet by the transfer nip 130, it is assumed that the sheet P is in a pushed state. Generally, if the sheet P is in a pulled state, the conveyance resistance of the sheet P is increased, such that the sheet conveyance torque Tq_p described above is increased. Meanwhile, if the sheet P is in a pushed state, the conveyance force from the registration roller pair 120 is added as torque for driving the intermediate transfer belt 145 to the belt drive motor 133, such that the sheet conveyance torque Tq_p is reduced.

The sheet having a high stiffness, such as thick paper, has a higher reaction force against the conveyance force received from the registration roller pair 120 and the transfer nip 130 and a higher reaction force when a loop is formed on the sheet, compared to the sheet having a low stiffness. Therefore, the sheet having a high stiffness will not easily change its posture even if the conveyance speed of the sheet P by the registration roller pair 120 changes from the nominal conveyance speed due to the tolerance of outer diameter dimension of the registration roller pair 120, and the fluctuation range of the distance X is small. That is, regardless of whether the sheet is in a pulled state or a pushed state, the sensitivity of the sheet conveyance torque Tq_p with respect to the difference in conveyance speed of the sheet between the registration roller pair 120 and the transfer nip 130 does not change.

Meanwhile, in the case of a sheet having a low stiffness, such as thin paper, the sheet posture may easily change due to the tolerance of outer diameter dimension of the registration roller pair 120. Further, especially in a case where the sheet is in a pushed state, the sensitivity of the sheet conveyance torque Tq_p with respect to the difference in conveyance speed of the sheet between the registration roller pair 120 and the transfer nip 130 will be low. This is because a loop is formed on the sheet by having the registration roller pair 120 push the sheet, and the conveyance force of the sheet by the registration roller pair 120 is transmitted to the belt drive motor 133 in a damped state.

Therefore, in a sheet having a relatively low stiffness, the distance X is required to fall within a fixed range so as not to cause image defects. The ideal range of the distance X is determined by causes such as the material of the intermediate transfer belt 145 or the voltage applied to the sheet.

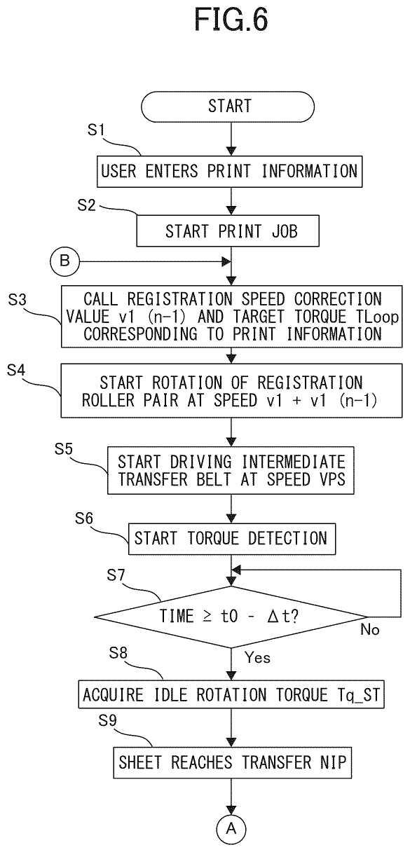

Therefore, according to the present embodiment, the control unit 210 executes conveyance control illustrated in FIG. 6 such that the posture upstream of the transfer nip 130 is stabilized within a range in which image defects do not occur even to sheets having a low stiffness.

### Registration Speed Control

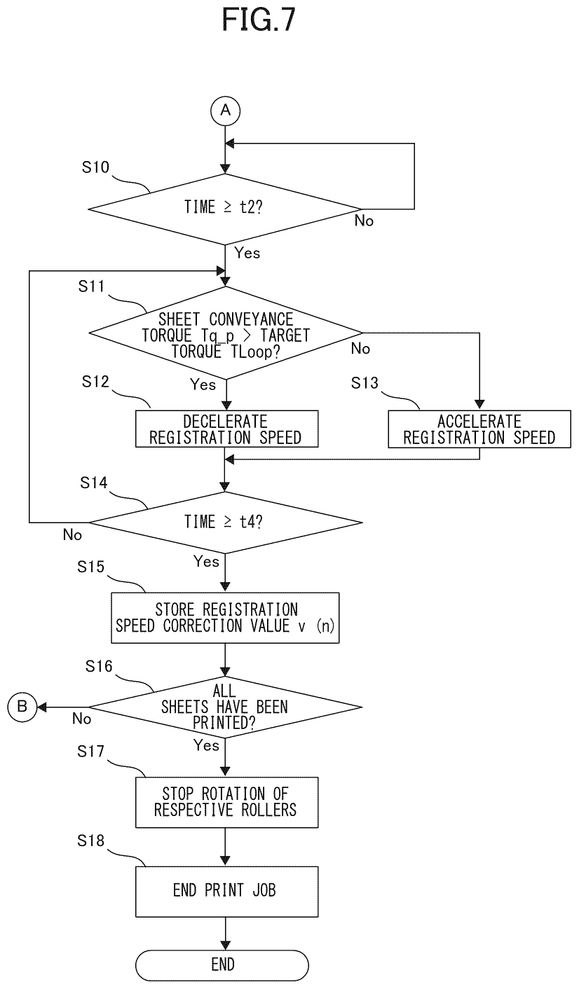

Next, with reference to FIGS. 6 and 7, a registration speed control serving as a conveyance control for controlling a rotational speed of the registration roller pair 120 by the control unit 210 will be described. FIGS. 6 and 7 are each a flowchart illustrating a print control including the registration speed control. According to the present embodiment, the registration speed control is executed in section B illustrated in FIG. 4, that is, from time t0 to time t4, but the present technique is not limited thereto. That is, the registration speed control is preferably executed for at least a part of the period of time from time t0 when the leading edge of the sheet P reaches the transfer nip 130 to time t4 when the trailing edge of the sheet P passes through the pre-registration roller pair 110.

The following description illustrates an example in which an operator causes the image forming apparatus 100 to execute a print job from the operation portion 220. In FIGS. 6 and 7, a print control focusing on the registration speed control according to the present embodiment is illustrated, and many other operations that are normally required to execute the job and output an image are omitted.

As illustrated in FIG. 6, the operator enters information such as the size and the grammage of the sheet P to be used through the operation portion 220 of the image forming apparatus 100 (S1). Thereafter, the operator executes a print job from the operation portion 220 (S2). The job information sent to the control unit 210 includes information related to the attribute of the sheet P. According to the present embodiment, the information related to the attribute of the sheet P includes at least the grammage and size information of the sheet P.

When the print job is executed, the control unit 210 calls, from the memory 212, a registration speed correction value v1 (n−1) to a sheet that is one sheet before the sheet being the target of registration speed control, and a target torque T_{Loop} described later (S3). The sheet being the target of registration speed control is the n-th sheet, and the sheet that is one sheet before the n-th sheet is the (n−1)-th sheet. The memory 212 stores a table including information related to the attribute of the sheet and the corresponding target torque T_{Loop}. Further, the control unit 210 sets up a printing operation condition that has been determined in advance for each attribute of the sheet P.

Next, after the skewing of the sheet P has been corrected by the registration roller pair 120, the control unit 210 starts to rotate the registration roller pair 120 (S4). In this state, the time is time t1 in FIG. 4, and the registration roller pair 120 rotates at speed V1+v1 (n−1). The speed V1 is a nominal rotational speed of the registration roller pair 120.

Next, the control unit 210 drives the belt drive motor 133 such that the intermediate transfer belt 145 moves at speed VPS (S5). Further, the control unit 210 starts to acquire the torque Tq of the belt drive motor 133 by the torque sensor 134 (S6).

Next, the control unit 210 determines whether time t0-Δt has arrived (S7). If it is determined that time t0-Δt has arrived (S7: Yes), the control unit 210 acquires the idle rotation torque value Tq_ST in a state where the sheet P is not nipped by the transfer nip 130 (S8). Then, at time to, the sheet P reaches the transfer nip 130 (S9).

Next, as illustrated in FIG. 7, the control unit 210 determines whether time t2 has arrived (S10). At time t2, the leading edge of the sheet P reaches the fixing nip 157. When it is determined that time t2 has arrived (S10: Yes), the control unit 210 executes a registration speed control in which a registration speed, which is a rotational speed of the registration roller pair 120, is controlled based on the target torque T_{Loop} that has been called in step S3, the idle rotation torque value Tq_ST acquired in step S8, and the torque Tq acquired in step S11.

At first, the sheet conveyance torque Tq_p is obtained based on the idle rotation torque value Tq_ST and the torque Tq detected by the torque sensor 134. The sheet conveyance torque Tq_p serving as a conveyance torque is obtained by subtracting the idle rotation torque value Tq_ST from the torque Tq. The torque Tq is a first torque of the belt drive motor 133 in a state where the sheet is nipped by the transfer nip 130. The idle rotation torque value Tq_ST is a second torque of the belt drive motor 133 in a state where the sheet is not nipped by the transfer nip 130.

The target torque T_{Loop} will be described below. The target torque T_{Loop} is an ideal value of the sheet conveyance torque Tq_p in section B of FIG. 4 according to the registration speed control of the present embodiment. The target torque T_{Loop} is a positive value according to which the sheet P is in a pulled state between the registration roller pair 120 and the transfer nip 130. In other words, a target torque is a torque of the belt drive motor 133 set such that a conveyance speed of the sheet conveyed by the transfer nip 130, i.e., first conveyance speed, is faster than a conveyance speed of the sheet conveyed by the registration roller pair 120, i.e., second conveyance speed. Nevertheless, the target torque T_{Loop} is set to such a value allowing the sheet P to be in a pulled state of a moderate level not causing damage to the sheet P, and the value may be set to different values according to the type and size of the sheet.

Then, the control unit 210 determines whether the sheet conveyance torque Tq_p is greater than the target torque T_{Loop} (S11). If the sheet conveyance torque Tq_p is greater than the target torque T_{Loop} (S11: Yes), the rotational speed of the registration roller pair 120 is decelerated, for example, by a predetermined value f (S12). Meanwhile, if the sheet conveyance torque Tq_p is equal to or smaller than the target torque T_{Loop} (S11: Yes), the rotational speed of the registration roller pair 120 is accelerated by the value f (S13). The value f for accelerating or decelerating the registration speed is not necessarily fixed, and a value (f1) for decelerating the registration speed may vary from the value (f2) for accelerating the value.

Next, the control unit 210 determines whether time t4 has arrived (S14). If it is determined that time t4 has not arrived (S14: No), the procedure returns to step S11. That is, the sheet conveyance torque Tq_p and the target torque T_{Loop} are compared until time t4 arrives, and feed-back control of the registration speed, which is the rotational speed of the registration roller pair 120, is performed. Thereby, the sheet P is controlled to be in a pulled state between the registration roller pair 120 and the transfer nip 130.

When the sheet P is in the pulled state, the non-imaging surface, i.e., surface opposite to the side onto which the toner image is transferred, of the sheet P comes into contact with the convex portion 301a of the guide member 301. Thereby, the sheet P is supported by three points, which are the registration roller pair 120, the convex portion 301a, and the transfer nip 130. In other words, the registration speed is controlled such that the sheet P is supported at three points, which are the registration roller pair 120, the convex portion 301a, and the transfer nip 130. That is, in registration speed control, the rotational speed of the registration roller pair 120 is controlled such that the first conveyance speed of the sheet by the transfer nip 130 is faster than the second conveyance speed of the sheet by the registration roller pair 120 based on the detection result of the torque sensor 134. In this state, the convex portion 301a is arranged such that the distance X described above in which the sheet P comes into sliding contact with the belt inclined surface 145a of the intermediate transfer belt 145 is within the range of distance X2 to distance X3.

According to the present embodiment, if the convex portion 301a is arranged in the area AR between the virtual line L1 that passes through the nip 120a of the registration roller pair 120 and the transfer nip 130 and the virtual line L2 that extends along the belt inclined surface 145a, the distance X is set to fall within the range of distance X2 to distance X3.

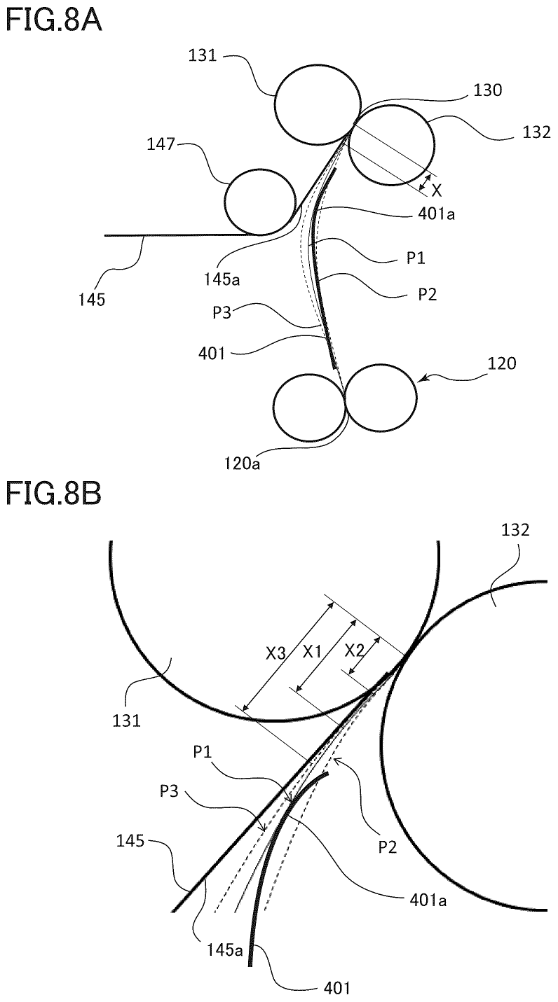

As illustrated in a modified example of FIGS. 8A and 8B, a guide member 401 includes a convex portion 401a, and the convex portion 401a may be arranged such that the distance X in which the sheet P comes into sliding contact with the belt inclined surface 145a of the intermediate transfer belt 145 is set to the ideal distance X1. In this state, the posture of the sheet P between the convex portion 401a and the transfer nip 130 is approximately the posture P1.

Returning to FIG. 6, when it is determined that time t4 has arrived (S14: Yes), the control unit 210 stores the registration speed correction value v1 (n) in the memory 212. The registration speed correction value v1 (n) is calculated, for example, by the following equation (1).

$$v 1 ( n ) = ( - f \cdot m 1 + f \cdot m 2 ) / ( m 1 + m 2 ) \qquad ( 1 )$$

m1: number of times of deceleration performed in step S12 based on registration speed control
m2: number of times of acceleration performed in step S13 based on registration speed control

The registration speed correction value v1 (n) is called from the memory 212 by the control unit 210 in step S3 when a next sheet, that is, the (n+1)-th sheet, is conveyed. Then, the control unit 210 determines whether all the number of sheets for printing designated in the print job have been printed (S16). If it is determined that not all the number of sheets designated in the print job have been printed (S16: No), the procedure returns to step S3.

If it is determined that all the number of sheets designated in the print job has been printed (S16: Yes), the control unit 210 stops the rotation of the respective rollers (S17), and ends the print job (S18). As described, the print control is ended.

As described, according to the present embodiment, the target torque T_{Loop} that causes the sheet P to be in a pulled state between the registration roller pair 120 and the transfer nip 130 is set. Therefore, the sheet P is supported by three points, which are the registration roller pair 120, the convex portion 301a, and the transfer nip 130, and the posture of the sheet conveyed by the transfer nip 130 is stabilized.

Further, even in a case of a sheet having a relatively low stiffness, such as thin paper, by setting the sheet to be in a pulled state, registration speed control may be performed in a range in which the sensitivity of the sheet conveyance torque Tq_p with respect to the difference in conveyance speeds of the sheet between the registration roller pair 120 and the transfer nip 130 is high. Therefore, the responsiveness of acceleration or deceleration of registration speed with respect to the posture of the sheet is enhanced, and the sheet may be conveyed in an appropriate posture. Therefore, the distance X in which the sheet P and the belt inclined surface 145a of the intermediate transfer belt 145 come in sliding contact may be set to fall within a suitable range that does not cause image defects. Thereby, image defects may be suppressed.

Further, when the sheet P is in a posture to move in sliding motion against the convex portion 301a of the guide member 301, the distance X described above will fall within the appropriate range where image defects will not occur, such that image defects may be suppressed. Further, the image forming apparatus 100 may be manufactured while allowing a tolerance of the outer diameter dimension of the registration roller pair 120, such that both image defects may be suppressed and costs may be cut down. Further, image defects may be suppressed even on a thin paper having a low stiffness, such that the number of corresponding media may be increased and the usability may be enhanced.

### Other Embodiments

According to the embodiments described above, a current detection unit that measures the current value of the belt drive motor 133 has been used as the torque sensor 134, but the present technique is not limited thereto. For example, a strain gauge that detects the torque of the belt drive motor 133 or an electrostatic capacitance torque sensor may also be used.

Further, the torque sensor 134 may detect, instead of the torque of the belt drive motor 133, a torque of any arbitrary member along the drive transmission path between the belt drive motor 133 and the driving roller 131.

According further to the embodiments described above, in the registration speed control, the rotational speed of the registration roller pair 120 was controlled such that the first conveyance speed of the sheet by the transfer nip 130 becomes faster than the second conveyance speed of the sheet by the registration roller pair 120 based on the detection result of the torque sensor 134, but the present technique is not limited thereto. That is, a torque detected by the torque sensor 134 in a state where the sheet is nipped and conveyed only by the transfer nip 130, referred to as a reference torque, may be stored in advance in the memory 212. Then, in the registration drive control, the rotational speed of the registration roller pair 120 may be controlled such that the torque detected by the torque sensor 134 when the sheet is nipped by the registration roller pair 120 and the transfer nip 130 becomes greater than the reference torque.

According further to the embodiments described above, the registration roller pair 120 was driven by the registration drive motor 121 which is independent from the belt drive motor 133, but the present technique is not limited thereto. For example, instead of the registration drive motor 121, a transmission mechanism capable of changing the rotational speed of the registration roller pair 120 by changing the speed of the drive from the belt drive motor 133 and transmitting the same to the registration roller pair 120 may be used.

According further to the embodiments described above, an example has been illustrated where the registration speed control is performed regardless of the attribute of the sheet, but the present technique is not limited thereto. For example, a configuration may be adopted in which the registration speed control is not performed for a sheet having a first stiffness, such as thick paper, and the registration speed control is performed for a sheet having a second stiffness that is smaller than the first stiffness, such as thin paper.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-081670, filed May 20, 2024, which is hereby incorporated by reference herein in its entirety.

What is claimed is:

1. An image forming apparatus comprising:
an image bearing member configured to bear a toner image;
a belt onto which the toner image is transferred from the image bearing member while the belt is being rotated in a rotational direction;
an outer roller configured to come into contact with an outer circumference surface of the belt;
an inner roller arranged to face the outer roller with the belt interposed therebetween, the inner roller being configured to come into contact with an inner circumference surface of the belt and to form a transfer nip with the outer roller;
a tension roller configured to come into contact with the inner circumference surface of the belt, the tension roller being disposed upstream of the inner roller in the rotational direction;
a conveyance roller pair configured to convey a sheet toward the transfer nip;
a guide member configured to guide the sheet being conveyed by the conveyance roller pair toward the transfer nip, the guide member including a convex portion that projects toward the outer circumference surface of the belt and that is arranged between a virtual line that passes through a nip of the conveyance roller pair and the transfer nip and a virtual line that extends along the outer circumference surface of the belt being stretched between the tension roller and the inner roller;
a belt drive motor configured to drive the belt;
a torque sensor configured to detect a torque of the belt drive motor; and
a control unit configured to execute, after the sheet has reached the transfer nip, a conveyance control of controlling a rotational speed of the conveyance roller pair such that a first conveyance speed of the sheet conveyed by the transfer nip becomes faster than a second conveyance speed of the sheet conveyed by the conveyance roller pair based on a detection result of the torque sensor.

2. The image forming apparatus according to claim 1, wherein the convex portion of the guide member is configured to be in sliding contact with the sheet nipped by the conveyance roller pair and the transfer nip in a case where the conveyance control is executed.

3. The image forming apparatus according to claim 1, wherein the control unit is configured to:
(i) acquire a target torque of the belt drive motor set such that the first conveyance speed becomes faster than the second conveyance speed, and a conveyance torque obtained by subtracting a second torque of the belt drive motor when the sheet is not nipped by the transfer nip from a first torque of the belt drive motor when the sheet is nipped by the transfer nip;
(ii) control, in the conveyance control, the rotational speed of the conveyance roller pair such that the second conveyance speed is decelerated in a case where the conveyance torque is greater than the target torque; and
(iii) control the rotational speed of the conveyance roller pair such that the second conveyance speed is accelerated in a case where the conveyance torque is smaller than the target torque.

4. The image forming apparatus according to claim 3, wherein the target torque is set according to an attribute of the sheet being conveyed.

5. The image forming apparatus according to claim 1, wherein the torque sensor includes a current detection unit configured to detect a current flowing to the belt drive motor.

6. The image forming apparatus according to claim 1, wherein the control unit executes the conveyance control for at least a part of a period of time from when the sheet has reached the transfer nip until the sheet passes through the conveyance roller pair.

7. The image forming apparatus according to claim 1, further comprising a conveyance motor configured to drive the conveyance roller pair,
wherein the control unit is configured to control the rotational speed of the conveyance roller pair by controlling the conveyance motor.

8. An image forming apparatus comprising:
an image bearing member configured to bear a toner image;
a belt onto which a toner image is transferred from the image bearing member while the belt is being rotated in a rotational direction;
an outer roller configured to come into contact with an outer circumference surface of the belt;
an inner roller arranged to face the outer roller with the belt interposed therebetween, the inner roller being configured to come into contact with an inner circumference surface of the belt and to form a transfer nip with the outer roller;
a tension roller configured to come into contact with the inner circumference surface of the belt, the tension roller being disposed upstream of the inner roller in the rotational direction;
a conveyance roller pair configured to convey a sheet toward the transfer nip;
a guide member configured to guide the sheet being conveyed by the conveyance roller pair toward the transfer nip, the guide member including a convex portion that projects toward the outer circumference surface of the belt and that is arranged between a virtual line that passes through a nip of the conveyance roller pair and the transfer nip and a virtual line that extends along the outer circumference surface of the belt being stretched between the tension roller and the inner roller;
a belt drive motor configured to drive the belt;
a torque sensor configured to detect a torque of the belt drive motor; and
a control unit configured to execute a conveyance control of controlling a rotational speed of the conveyance roller pair such that a torque detected by the torque sensor when the sheet is nipped by the conveyance roller pair and the transfer nip becomes greater than a torque detected by the torque sensor when the sheet is nipped and conveyed only by the transfer nip.

9. The image forming apparatus according to claim 8, wherein the convex portion of the guide member is configured to be in sliding contact with the sheet nipped by the conveyance roller pair and the transfer nip in a case where the conveyance control is executed.

10. The image forming apparatus according to claim 8, wherein the torque sensor includes a current detection unit configured to detect a current flowing to the belt drive motor.

11. The image forming apparatus according to claim 8, wherein the control unit executes the conveyance control for at least a part of a period of time from when the sheet has reached the transfer nip until the sheet passes through the conveyance roller pair.

12. The image forming apparatus according to claim 8, further comprising a conveyance motor configured to drive the conveyance roller pair,
wherein the control unit is configured to control the rotational speed of the conveyance roller pair by controlling the conveyance motor.
